(19) United States
(12) Patent Application Publication
(10) Pub. No.: US 2011/0261908 A1
(43) Pub. Date: Oct. 27, 2011

(54) SOFT DEMAPPING METHOD AND APPARATUS AND COMMUNICATION SYSTEM THEREOF

(75) Inventors: Hsiao-Lan Chiang, Miaoli County (TW); Pang-An Ting, Taichung County (TW); Chih-Yu Chen, Yilan County (TW)

(73) Assignee: INDUSTRIAL TECHNOLOGY RESEARCH INSTITUTE, Hsinchu (TW)

(21) Appl. No.: 12/897,797

(22) Filed: Oct. 5, 2010

(30) Foreign Application Priority Data
Apr. 27, 2010 (TW) 99113292

(51) Int. Cl. H04L 27/06

(52) U.S. Cl. 375/341

(57) ABSTRACT

An exemplary embodiment of the present disclosure provides a soft demapping method. In the soft demapping method, each shortest Euclidean distance of the Euclidean distances from all possible signal vectors corresponding to the bits which are not obtained during a signal detection to a received signal vector is calculated by using channel state information (CSI) and modulation coefficients, so as to establish a complete bit vector-shortest distance mapping table, and a log likelihood ratio (LLR) of each bit is obtained according to the bit vector-shortest distance mapping table. The soft demapping method can be applied along with different signal detection techniques to decode a received signal vector into a bit vector, wherein the signal detection techniques include a maximum likelihood detection (MLD) technique and a sphere decoding (SD) technique.

### CROSS-REFERENCE TO RELATED APPLICATION

This application claims the priority benefit of Taiwan application serial no. 99113292, filed on Apr. 27, 2010. The entirety of the above-mentioned patent application is hereby incorporated by reference herein and made a part of this specification.

### TECHNICAL FIELD

The present disclosure generally relates to a communication system, and more particularly, to a soft demapping method adaptable to a receiver in a communication system and an apparatus using the same.

### BACKGROUND

In recent years, the wired/wireless communication technologies have been rapidly developed. Accordingly, people can surf the Internet or talk with others through communication devices having communication functions at anywhere and anytime. Presently, multiple-input multiple-output (MIMO) systems are broadly used in order to prevent wireless channels from affecting signal vectors and allow receivers to receive these signal vectors successfully. A receiver usually adopts the sphere decoding (SD) or maximum likelihood detection (MLD) technique for detecting signals.

According to the MLD technique, a signal vector closest to a received signal vector is selected from all possible signal vectors, and the signal vector closest to the received signal vector is the signal vector transmitted by a transmitter if no erroneous decoding is considered. The signal vector determined through MLD is expressed as \hat{x}=arg min_{xεS}(∥y−Hx∥²), wherein y is the received signal vector, H is a system channel matrix, x is any signal vector within a set S, and the set S contains all possible signal vectors. The signal vector \hat{x} obtained through MLD may be the optimal solution.

Unlike that all the signal vectors have to be searched in the MLD technique, in the SD technique, only some signal vectors are searched and a signal vector closest to the received signal vector is selected among the searched signal vectors. Since only some signal vectors are searched, the Euclidean distances from other signal vectors to the received signal vector are not calculated in the SD technique. The signal vector obtained through SD is a sub-optimal solution.

After detecting a signal vector, a receiver demaps the signal vector to obtain the weight (or referred to as transmission possibility) of each bit carried by the signal vector, which might be hard demapping or soft demapping. Take hard demapping as an example, with a quadrature phase-shift keying (QPSK) technique modulation scheme, a real signal and an imaginary signal are respectively demodulated, the bit corresponding to the real signal is 0 if the real signal equals −1 on the real number axis of a constellation map, and the bit corresponding to the real signal is 1 if the real signal equals 1 on the real number axis of the constellation map. Similarly, the bit corresponding to the imaginary signal is 0 if the imaginary signal equals −1 on the imaginary number axis of the constellation map, and the bit corresponding to the imaginary signal is 1 if the imaginary signal equals 1 on the imaginary number axis of the constellation map; on the other hand, soft demapping includes not only definite value of 0 or 1 but also another information like channel gain or noise term.

When the communication system is a single-input single-output (SISO) system (i.e., the transmitter and the receiver of the communication system respectively have a single antenna) with QPSK modulation, after the receiver detecting the signal vector \hat{x}=[\hat{x}₁ \hat{x}_{2]}^{T}=[−1 1]^{T}, it demaps the signal vector into a bit vector \hat{b}=[\hat{b}₁ \hat{b}_{2]}^{T}=[0 1]^{T}, where the signals \hat{x}₁ and \hat{x}₂ are respectively a real part and an imaginary part of signal. Regarding a QPSK signal, the real signal and the imaginary signal thereof are respectively corresponding to one bit (i.e., \hat{x}₁→\hat{b}₁ and \hat{x}₂→\hat{b}₂).

A demapping technique can be either a hard demapping technique or a soft demapping technique. For a hard demapping technique, signal vector is directly demapped into a plurality of bit. A soft demapping technique is to calculate a plurality of log likelihood ratios (LLRs) of the bits in the bit vector corresponding to the signal vector and then obtain a plurality of bit values in the bit vector corresponding to the signal vector according to the LLRs. A LLR could be defined as:

$$\hat{L} ( {b}_{n} ) = {min}_{x ∈ {S}_{{b}_{n} = 1}} ( \frac{1}{{σ}^{2}} ) {‖ y - Hx ‖}^{2} - {min}_{x ∈ {S}_{{b}_{n} = 0}} ( \frac{1}{{σ}^{2}} ) {‖ y - Hx ‖}^{2} ,$$

where y is a received signal vector, H is a system channel matrix, x is the signal vector, σ² is a noise power, S_{bn=1} is a set of all possible signal vectors with the bit bₙ=1, S_{bn=0} is a set of all possible signal vectors with bₙ=0, n=1, . . . , N_{T}M_{c}, N_{T} is the number of transmit antennas, and M_{c} is the bit number of each real or imaginary signal on the constellation map.

FIG. 1A is a schematic diagram illustrating a conventional method for a receiver to obtain a bit vector through MLD and soft demapping, and FIG. 1B is a schematic diagram illustrating the Euclidean distance from each signal vector in a set of all possible signal vectors combined with channel state information to a received signal vector. Referring to FIG. 1A and FIG. 1B, a MLD module 100 of the receiver executes MLD on the received signal vector y, so as to detect the most possible transmit signal vector \hat{x}=[\hat{x}₁ \hat{x}_{2]}^{T} within the set S, where the signals \hat{x}₁ and \hat{x}₂ are respectively a real and imaginary part of signal obtained by the receiver.

FIG. 1B shows a SISO communication system adopting QPSK modulation technique. The MLD module 100 calculates the Euclidean distance from each signal vector in the set S combined with channel state information and the received signal vector y, so as to detect the most possible transmit signal vector \hat{x}=[\hat{x}₁ \hat{x}_{2]}^{T}. As shown in FIG. 1B, there are four combinations of transmitted signals and their Euclidean distances are as follows: the Euclidean distance of x=[1 1]^{T} is 0.1, the Euclidean distance of x=[1 −1]^{T} is 0.5, the Euclidean distance of x=[−1 1]^{T} is 0.3, and the Euclidean distance of x=[−1 −1]^{T} is 0.7. Thus, the MLD module 100 determines that the signal vector \hat{x}=[1 1]^{T} due to the minimum Euclidean distance.

In order to execute the soft demapping operation, the receiver has to obtain the shortest Euclidean distances from all corresponding signal vectors respectively with b₁=1, b₁=0, b₂=1, and b₂=0. Thus, the receiver records the Euclidean distances corresponding to all the bit vectors b and received signal vector y in a bit vector-distance mapping table 110. For example, the Euclidean distance of x=[−1 −1]^{T} corresponding to the bit vector b=[0 0]^{T} and received signal vector y in the bit vector-distance mapping table 110 is 0.7.

The \hat{x}=[11]^{T} is the minimum Euclidean distance signal vector based on MLD module 100, thus the receiver records the minimum Euclidean distance P₁¹=0.1 when bit b₁=1 corresponding to all the signal vectors and received signal vector y in the bit vector-shortest distance mapping table 120. Similarity, the receiver records the minimum Euclidean distance P₂¹=0.1 when bit b₂=1 corresponding to all the signal vectors and received signal vector y in the bit vector-shortest distance mapping table 120.

In addition, the Euclidean distance of signal vectors corresponding to the bit vector b=[0 1]^{T} and received signal vector y in the bit vector-distance mapping table 110 is 0.3 and the Euclidean distance of signal vectors corresponding to the bit vector b=[0 0]^{T} and received signal vector y is 0.7. Thus, the receiver records the minimum Euclidean distance P₁⁰=0.3 when bit b₁=0 corresponding to all the signal vectors and received signal vector y in the bit vector-shortest distance mapping table 120.

Similarity, the Euclidean distance of signal vectors corresponding to the bit vector b=[1 0]^{T} and received signal vector y in the bit vector-distance mapping table 110 is 0.5 and the Euclidean distance of signal vectors corresponding to the bit vector b=[0 0]^{T} and received signal vector y is 0.7. Thus, the receiver records the minimum Euclidean distance P₂⁰=0.5 when bit b₂=0 corresponding to all the signal vectors and received signal vector y in the bit vector-shortest distance mapping table 120.

The receiver executes a soft demapping operation based on the content recorded in the bit vector-shortest distance mapping table 120 to calculate the LLR of b₁ \hat{L}(b₁)=P₁¹−P₁⁰=−0.2, so as to judge the bit b₁=1 is transmitted by the transmitter. Similarly, the receiver executes a soft demapping operation based on the content recorded in the bit vector-shortest distance mapping table 120 to calculate the LLR of b₂ \hat{L}(b₂)=P₂¹−P₂⁰=−0.4, so as to judge the bit b₂=1 is transmitted by the transmitter.

FIG. 2A is a schematic diagram illustrating a method for a receiver to obtain soft values through SD, FIG. 2B is a schematic diagram illustrating the distance from partial signal vectors, and FIG. 2C is also a schematic diagram illustrating the distance from partial signal vector but its searching order is different to FIG. 2B (in FIG. 2B, it searches x₂ first; however, in FIG. 2C, it searches x₁ first). Referring to FIG. 2A-2C, the receiver executes SD (modules 210 and 220), where module 210 decodes the signal x₂ as a first-level signal, and module 220 decodes decodes the signal x₁ as a first-level signal. In the present example, the signal vector x contains two levels of signals (i.e., the signals x₁ and x₂ which are respectively a real and imaginary part of signal.

Assuming a SISO system adopting the QPSK modulation technique, as shown in FIG. 2A and FIG. 2B, the SD module 210 only searches the set S₁ that contains the signal vectors x=[x₁ x_{2]}^{T}=[1 1]^{T} and [1 −1]^{T} and detects that the signal vector \hat{x}=[1 1]^{T} is the transmitted one. Since the signal vectors x=[x₁ x_{2]}^{T}=[−1 1]^{T} and [−1 −1]^{T} are not searched, the receiver only records the Euclidean distance from the signal vectors corresponding to the bit vectors b=[b₁ b_{2]}^{T}=[1 1]^{T} and [1 0]^{T} in the bit vector-distance mapping table 212. In other words, the SD module 210 does not calculate the Euclidean distance from the signal vectors corresponding to the bit vectors b=[b₁ b_{2]}^{T}=[0 1]^{T} and b=[0 0]^{T}. Thus, the bit vector-distance mapping table 212 does not store the Euclidean distance from each of the signal vectors corresponding to the bit vectors b=[b₁ b_{2]}^{T}=[0 1]^{T} and b=[0 0]^{T}.

In addition, as shown in FIG. 2A and FIG. 2C, the SD module 220 only searches the set S₂ that contains the signal vectors x=[x₁ x_{2]}^{T}=[1 1]^{T} and [−1 1]^{T} and detects that the signal vector \hat{x}=[1 1]^{T} is the transmitted one. Since the signal vector s x=[x₁ x_{2]}^{T}=[1 1]^{T} and [−1 1]^{T} are not searched, the receiver only records the Euclidean distance from the signal vectors corresponding to the bit vectors b=[b₁ b_{2]}^{T}=[1 1]^{T} and [0 1]^{T} in the bit vector-distance mapping table 222. In other words, the SD module 220 does not calculate the Euclidean distance from each of the signal vectors corresponding to the bit vectors b=[b₁ b_{2]}^{T}=[1 1]^{T} and [0 1]^{T}. Thus, the bit vector-distance mapping table 212 does not store the Euclidean distance from each of the signal vectors corresponding to the bit vectors b=[b₁ b_{2]}^{T}=[1 1]^{T} and [0 1]^{T}.

Next, the receiver respectively establishes an uncomplete bit vector-shortest distance mapping table 214 and an uncomplete bit vector-shortest distance mapping table 224 according to the uncomplete bit vector-distance mapping tables 212 and 222. Because the uncomplete bit vector-distance mapping table 212 does not store the Euclidean distance from each of the signal vectors corresponding to the bit vectors b=[0 1]^{T} and b=[0 0]^{T} and combined with the channel to the received signal vector y, the uncomplete bit vector-shortest distance mapping table 214 does not store the shortest Euclidean distance P₁⁰ of the Euclidean distances from all the corresponding signal vectors with b₁=0 combined with the channel to the received signal vector y. Similarly, because the uncomplete bit vector-distance mapping table 222 does not store the Euclidean distance from each of the signal vector corresponding to the bit vectors b=[1 0]^{T} and b=[0 0]^{T} and combined with the channel to the received signal vector y, the uncomplete bit vector-shortest distance mapping table 224 does not store the shortest Euclidean distance P₂⁰ of the Euclidean distances from all the corresponding signal vectors with b₂=0 to the received signal vector y.

Thereafter, the receiver establishes a complete bit vector-shortest distance mapping table 230 according to the uncomplete bit vector-shortest distance mapping tables 214 and 224. The receiver executes a soft demapping operation based on the content recorded in the complete bit vector-shortest distance mapping table 230 to calculate the LLR L(b₁)=P₁¹−P₁⁰=−0.2, so as to judge the bit b₁=1 is transmitted by the transmitter. Similarly, the receiver executes a soft demapping operation based on the content recorded in the complete bit vector-shortest distance mapping table 230 to calculate the LLR L(b₂)=P₂¹−P₂⁰=−0.4, so as to judge the bit b₂=1 is transmitted by the transmitter.

### SUMMARY

A soft demapping method, a soft demapping apparatus, and a communication system are introduced herein.

According to an exemplary embodiment of the present disclosure, a soft demapping method adaptable to a receiver in a communication system is provided to obtain a log likelihood ratio (LLR) of each bit in a received signal vector. The receiver receives the received signal vector y=[y₁y₂ . . . y_{N}_{_{R}}]^{T}, all possible signal vectors transmitted by a transmitter in the communication system are expressed as x=[x₁ x₂ . . . x_{N}_{_{T}}]^{T}, and a plurality of bits corresponding to a signal at each level is expressed as [b_{(l-1)Mc+1}b_{(l-1)Mc+2} . . . b_{(l-1)Mc+Mc]}^{T}, wherein l=2 j−1 corresponds to the real bits, and the l=2j corresponds to the imaginary bits, j is an integer from 1 and N_{T}, N_{T} is a total singal number of the possible signal vector, and M_{c} is the number of real or imaginary bits corresponding to the signal xⱼ at the level j. The soft demapping method includes following steps. In a step A, a signal detection is executed on the received signal vector y to establish a bit vector-shortest distance mapping table. The completeness of the bit vector-shortest distance mapping table is determined by the size of a searched transmitted signal set, and the smaller the transmitted signal set is, the more incomplete the bit vector-shortest distance mapping table is. In a step B, values corresponding to the uncompleted part of the bit vector-shortest distance mapping table established in step A are calculated. If the shortest distances of some bit vectors corresponding to the signal Xⱼ at the level j are not obtained through the signal detection, the shortest Euclidean distance P_{j,n} of the Euclidean distances from the corresponding signal vectors with each bit bₙ being erroneous when the signal Xⱼ at the level j is incorrect and the signals X_{i,i≠j} at other levels are all correct to the received signal vector y is calculated according to each column vector hⱼ of a system channel matrix H, wherein n is an integer from 1 to N_{T}M_{c}. The order of the steps A and B can be reversed. Namely, in step B, each column vector hⱼ is roughly estimated, and the shortest Euclidean distance of each bit vector is recorded in the bit vector-shortest distance mapping table. Then, in step A, if the shortest Euclidean distance of a specific bit vector is obtained, the value thereof in the bit vector-shortest distance mapping table is updated. After that, in a step C, a complete bit vector-shortest distance mapping table is established according to each shortest Euclidean distance P_{j,n} and the incomplete bit vector-shortest distance mapping table.

According to an exemplary embodiment of the present disclosure, a soft demapping apparatus adaptable to a receiver in a communication system is provided to obtain a LLR of each bit in a received signal vector. The receiver receives the received signal vector y=[y₁y₂ . . . y_{N}_{_{R}}]^{T}, all possible signal vectors transmitted by a transmitter in the communication system are expressed as x=[x₁ x₂ . . . x_{N}_{_{T}}]^{T}, and a plurality of bits corresponding to the signal at each level is expressed as [b_{(l-1)Mc+1}b_{(l-1)Mc+2} . . . b_{(l-1)Mc+Mc]}^{T}, wherein l=2j−1 corresponds to real bits, and the corresponds to imaginary bits, j is an integer from 1 and N_{T}, N_{T} is a total signal number of the possible signal vector, and M_{c} is the number of real or imaginary bits corresponding to the signal xⱼ at the level j. The soft demapping apparatus includes a bit vector-shortest distance mapping table module, a channel state information (CSI) extracting unit, and a calculation unit. The bit vector-shortest distance mapping table module establishes a bit vector-shortest distance mapping table according to the result of a signal detection executed by the signal detecting module on the received signal vector y, wherein the completeness of the bit vector-shortest distance mapping table is determined by the size of a searched transmitted signal set, and the smaller the transmitted signal set is, the more incomplete the bit vector-shortest distance mapping table is. The CSI extracting unit extracts each column vector hⱼ of a system channel matrix H from a channel estimation device. The calculation unit calculates values corresponding to the uncompleted part of the bit vector-shortest distance mapping table. Herein the shortest Euclidean distance P_{j,n} of the Euclidean distances from the corresponding signal vectors with each bit bₙ being erroneous when the signal xⱼ at the level j is incorrect and the signals x_{i,i≠j} at other levels are all correct to the received signal vector y is calculated according to each column vector hⱼ of the system channel matrix H, wherein k is an integer from 1 to N_{T}M_{c}. It should be noted that the execution order of the bit vector-shortest distance mapping table module and the calculation unit can be reversed. Namely, the calculation unit first obtains each roughly estimated column vector hⱼ and records the shortest Euclidean distance of each bit vector in the bit vector-shortest distance mapping table. Then, the bit vector-shortest distance mapping table module updates the corresponding value in the bit vector-shortest distance mapping table if it obtains the shortest Euclidean distance of a specific bit vector. In addition, the bit vector-shortest distance mapping table module further establishes a complete bit vector-shortest distance mapping table according to each shortest Euclidean distance P_{j,n} and the incomplete bit vector-shortest distance mapping table.

According to an exemplary embodiment of the present disclosure, a communication system including a receiver and a transmitter is provided. The receiver includes a soft demapping apparatus and a signal detecting module. The soft demapping apparatus obtains a LLR of each bit in a received signal vector. The receiver receives the received signal vector y=[y₁y₂ . . . y_{N}_{_{R}}]^{T}. All possible signal vectors transmitted by the transmitter are expressed as x=[x₁ x₂ . . . y_{N}_{_{T}}]^{T}, and a plurality of bits corresponding to the signal xⱼ at each level is expressed as [b_{(l-1)Mc+1} b_{(l-1)Mc+2} . . . b_{(l-1)Mc+Mc]}^{T}, wherein corresponds to real bits, and the l=2j corresponds to imaginary bits, j is an integer from 1 and N_{T}, N_{T} is a total signal number of the possible signal vector, and M_{c} is the number of real or imaginary bits corresponding to the signal Xⱼ at the level j. The soft demapping apparatus includes a bit vector-shortest distance mapping table module, a CSI extracting unit, and a calculation unit. The bit vector-shortest distance mapping table module establishes a bit vector-shortest distance mapping table according to the result of a signal detection executed by the signal detecting module on the received signal vector y, wherein the completeness of the bit vector-shortest distance mapping table is determined by the size of a searched transmitted signal set, and the smaller the transmitted signal set is, the more incomplete the bit vector-shortest distance mapping table is. The CSI extracting unit extracts each column vector hⱼ of a system channel matrix H from a channel estimation device. The calculation unit calculates values corresponding to the uncompleted part of the bit vector-shortest distance mapping table. Herein the shortest Euclidean distance P_{j,n} of the Euclidean distances from the corresponding signal vectors with each bit bₙ being erroneous when the signal Xⱼ at the level j is incorrect and the signals x_{i,i≠j} at other levels are all correct to the received signal vector y is calculated according to each column vector hⱼ of the system channel matrix H, wherein k is an integer from 1 to N_{T} M_{c}. It should be noted that the execution order of the bit vector-shortest distance mapping table module and the calculation unit can be reversed. Namely, the calculation unit first obtains each roughly estimated column vector hⱼ and records the shortest Euclidean distance of each bit vector in the bit vector-shortest distance mapping table. Then, the bit vector-shortest distance mapping table module updates the corresponding value in the bit vector-shortest distance mapping table if it obtains the shortest Euclidean distance of a specific bit vector. In addition, the bit vector-shortest distance mapping table module further establishes a complete bit vector-shortest distance mapping table according to each shortest Euclidean distance P_{j,n} and the incomplete bit vector-shortest distance mapping table.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a schematic diagram illustrating a conventional method for a receiver to obtain a bit vector through maximum likelihood detection (MLD) and soft demapping.

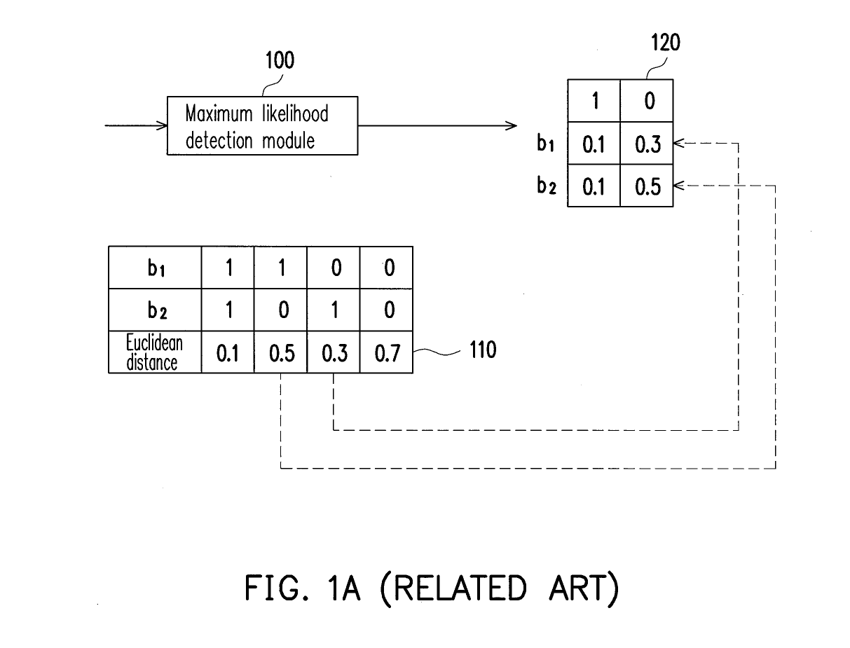

FIG. 1B is a schematic diagram illustrating the Euclidean distance from each signal vector in a set of all possible signal vectors combined with channel state information to a received signal vector.

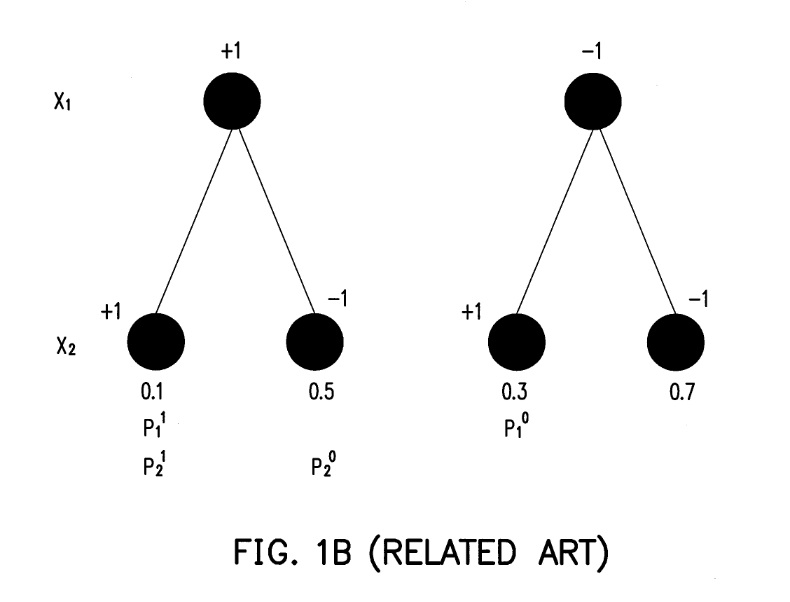

FIG. 2A is a schematic diagram illustrating a method for a receiver to obtain soft values through sphere decoding (SD).

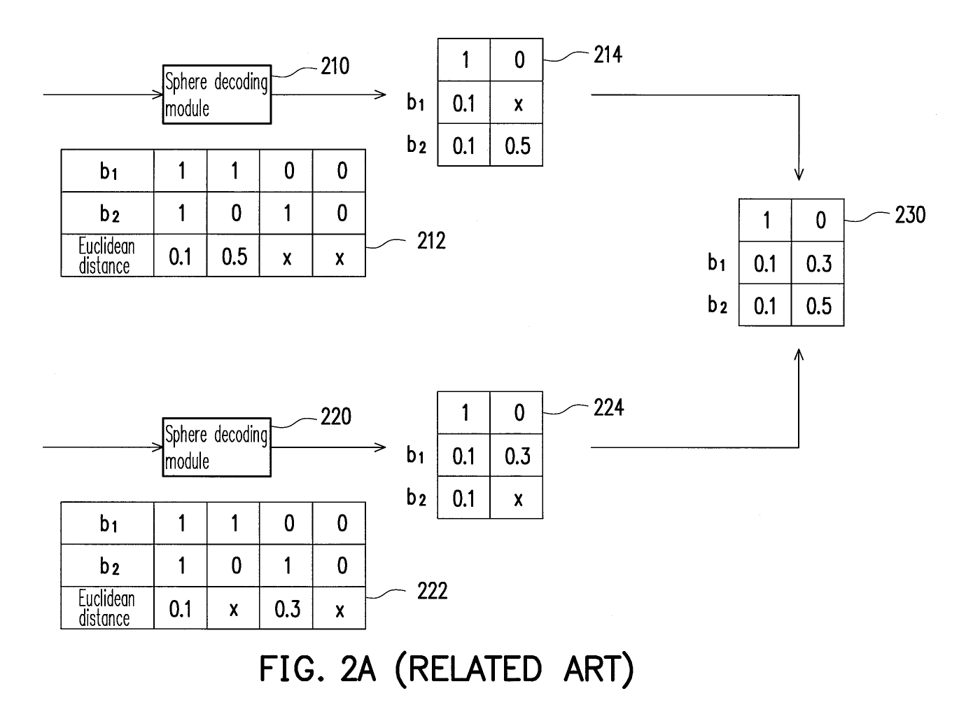

FIG. 2B is a schematic diagram illustrating the distance from partial signal vectors.

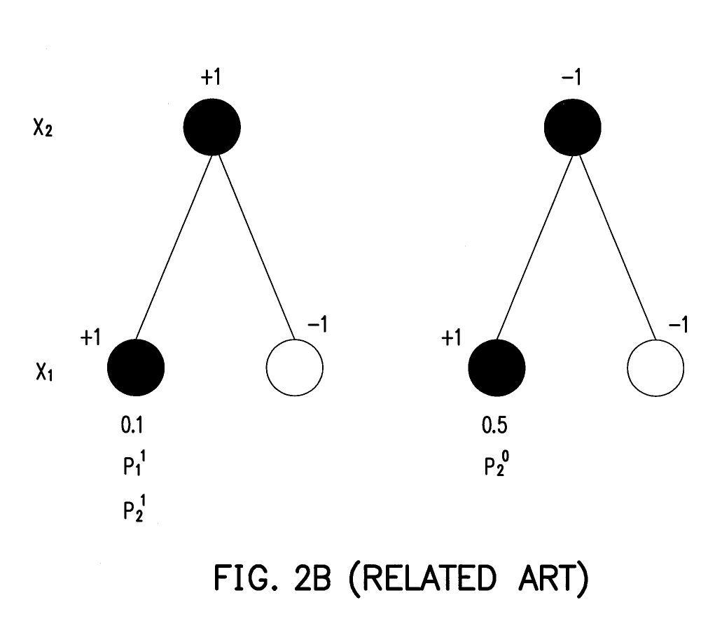

FIG. 2C is a schematic diagram illustrating the distance from partial signal vectors, but its searching order is different to FIG. 2B.

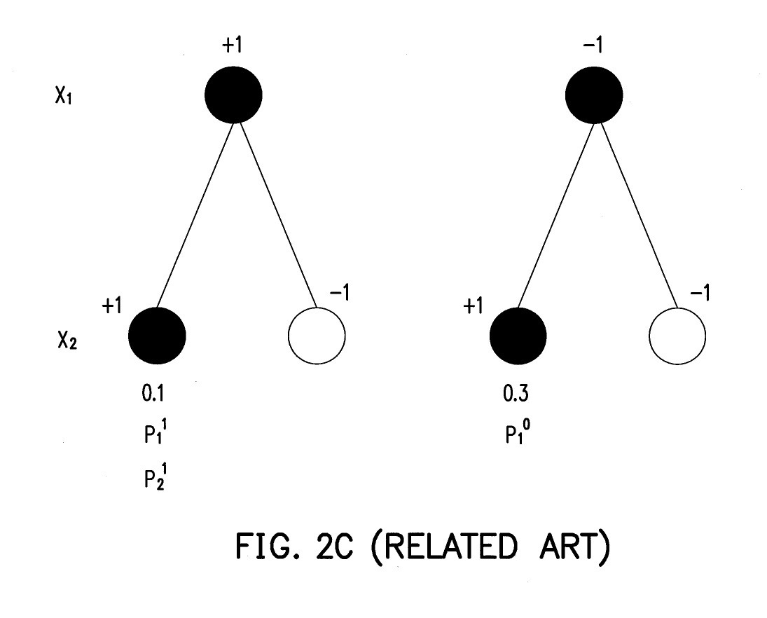

FIG. 3A is a schematic diagram illustrating a method for a receiver to obtain a bit vector through SD and a soft demapping method according to an exemplary embodiment.

FIG. 3B is a schematic diagram illustrating the distance from each signal vector in a set of some possible signal vectors to a received signal vector.

FIG. 4A is a schematic diagram illustrating a constellation map of signal xⱼ corresponding to a bit bₙ and a bit bₙ₊₁ when a communication system adopts a 16 quadrature amplitude modulation (16QAM) technique.

FIG. 4B is a schematic diagram illustrating a constellation map of signal xⱼ corresponding to a bit bₙ, a bit bₙ₊₁, and a bit bₙ₊₂ when a communication system adopts a 64 quadrature amplitude modulation (64QAM) technique.

FIG. 5 is a block diagram of a communication system according to an exemplary embodiment.

FIG. 6 is a block diagram of a soft demapping apparatus according to an exemplary embodiment.

FIG. 7 is a flowchart of a soft demapping method according to an exemplary embodiment.

FIG. 8 is a schematic diagram of a bit vector-shortest distance mapping table according to an exemplary embodiment.

### DETAILED DESCRIPTION OF DISCLOSED EMBODIMENTS

An exemplary embodiment provides a soft demapping method, wherein each shortest Euclidean distance of the Euclidean distances from all the signal vectors corresponding to those bits that are not calculated during a signal detection and a received signal vector is calculated to establish a complete bit vector-shortest distance mapping table, and a log likelihood ratio (LLR) of each bit is obtained according to the bit vector-shortest distance mapping table. The present soft demapping method can be applied along with different signal detection techniques to decode a received signal vector into a bit vector, wherein the signal detection techniques include a maximum likelihood detection (MLD) technique and a sphere decoding (SD) technique.

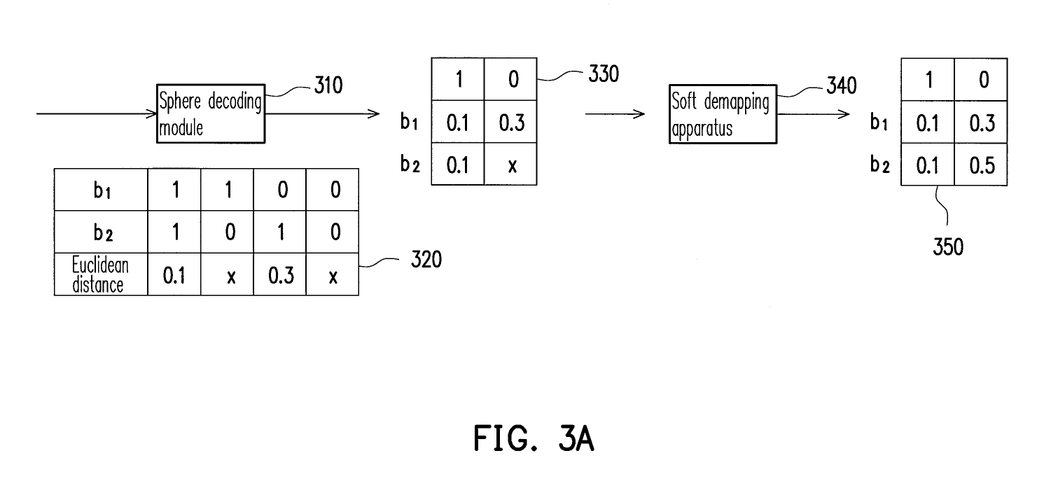

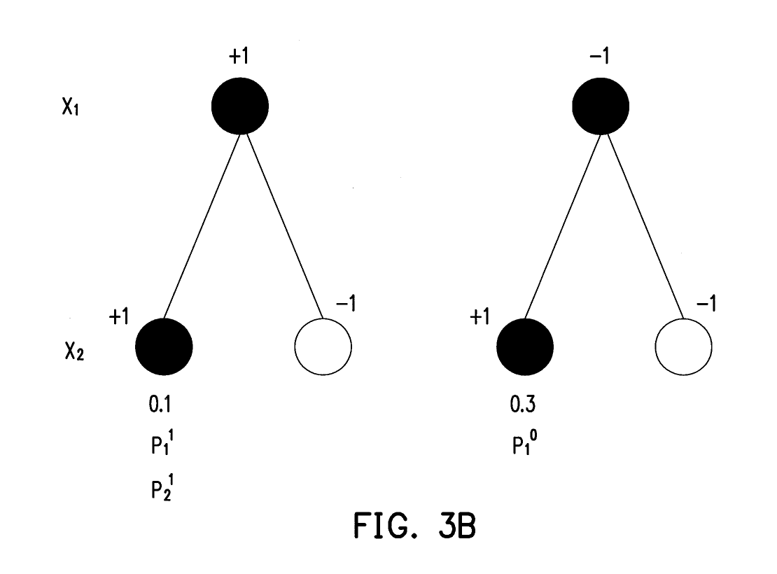

FIG. 3A is a schematic diagram illustrating a method for a receiver to obtain a bit vector through SD and a soft demapping method according to an exemplary embodiment, and FIG. 3B is a schematic diagram illustrating the distance from each signal vector in a set of some possible signal vectors to a received signal vector. Referring to FIG. 3A and FIG. 3B, the communication system adopts the quadrature phase-shift keying (QPSK) technique, and the receiver and the transmitter respectively have a single antenna. The receiver obtains a received signal vector y=[y₁y_{2]}^{T} through a wireless channel, and the received signal vector y=[y₁y_{2]}^{T} have two received signals y₁ and y₂ at two different levels, wherein the received signals y₁ and y₂ respectively represent a real received signal and an imaginary received signal.

In FIG. 3A and FIG. 3B, a SD module 310 of the receiver executes a signal detection on the received signal vector y, wherein the signal detection is SD. The SD module 310 only searches a set Sₓ_{₂}₌₁ that contains the signal vector x=[x₁ x_{2]}^{T}=[±1 1]^{T} and finds a signal vector \hat{x}=[1 1]^{T} that is closest to the received signal vector y from the set Sₓ_{₂}₌₁ according to the corresponding Euclidean distances. The signals \hat{x}₁ and \hat{x}₂ in in the signal vector \hat{x} solved by the receiver respectively represent a real signal and an imaginary signal solved by the receiver. Since the QPSK technique is adopted by the communication system, the signals \hat{x}₁ and \hat{x}₂ are respectively corresponding to a bit b₁ and a bit b₂ after they are demapped. Additionally, the signals \hat{x}₁ and \hat{x}₂ in the signal vector x respectively represent a real signal and an imaginary signal.

In the present exemplary embodiment, since the signal vector x=[±1 −1]^{T} is not searched, the receiver records the Euclidean distance from each of the signal vectors corresponding to the bit vectors b=[b₁ b_{2]}^{T}=[1 1]^{T} and b=[0 1]^{T} to the received signal vector y into a bit vector-distance mapping table 320. In other words, the SD module 310 does not calculates the Euclidean distance from each of the signal vectors corresponding to the bit vectors b=[1 0]^{T} and b=[0 0]^{T} to the received signal vector y. Thus, the bit vector-distance mapping table 320 does not store the Euclidean distance from each of the signal vectors corresponding to the bit vectors b=[1 0]^{T} and b=[0 0]^{T} to the received signal vector y.

The receiver establishes a bit vector-shortest distance mapping table 330 according to the bit vector-distance mapping table 320. Since the bit vector-distance mapping table 320 does not store the Euclidean distance from each of the signal vectors corresponding to the bit vectors b=[1 0]^{T} and b=[0 0]^{T} to the received signal vector y, the bit vector-shortest distance mapping table 330 does not records the shortest Euclidean distance P₂⁰ of the Euclidean distances from all the corresponding signal vectors with b₂=0 to the received signal vector y. Namely, the completeness of the bit vector-shortest distance mapping table 330 is determined by the size of the searched set Sₓ_{₂}₌₁ of transmitted signals, and the smaller the transmitted signal set Sₓ_{₂}₌₁ is, the more incomplete the bit vector-shortest distance mapping table 330 is. However, the shortest Euclidean distance P₂⁰ has to be obtained, such that the receiver can execute a soft demapping operation to obtain the bit vector transmitted by the transmitter.

Thereby, the present exemplary embodiment provides a soft demapping method for obtaining each shortest Euclidean distance of the Euclidean distances from all the signal vectors corresponding to the bits that are not calculated during the signal detection to the received signal vector y. A soft demapping apparatus 340 using the soft demapping method provided in the present exemplary embodiment calculates the shortest Euclidean distance P₂⁰. After that, the soft demapping apparatus 340 establishes a complete bit vector-shortest distance mapping table 350 and obtains the bit vector transmitted by the transmitter according to the bit vector-shortest distance mapping table 350.

The received signal vector y is expressed as y=HX+n, wherein H is a system channel matrix, and n is a noise vector. Through the operations of the SD module 310, the signal vector transmitted by the transmitter may be determined to be the signal vector \hat{x}=[1 1]^{T}. In the soft demapping method provided in the present exemplary embodiment, the shortest one of the Euclidean distances from the received signal vector y to all the signal vectors corresponding to some incorrect bits is calculated based on a very high signal to noise ratio (SNR), wherein the shortest one of the Euclidean distances from the received signal vector y to all the signal vectors corresponding to some incorrect bits cannot be obtained by executing the SD quickly through maximum likelihood judgment. Additionally, according to a simulation, it shows that this technique is still applicable when the SNR is very low.

Assuming that the signal \hat{x}₁ at the first level is correct (i.e., x₁=1=\hat{x}₁, wherein x₁ is a transmitted signal), the calculation of erroneous vector in the maximum likelihood judgment is expressed as y−Hx=[h₁₂h_{22]}^{T}(x₂−\hat{x}₂)+[n₁n_{2]}^{T}. When the signal x₂ at the second level satisfies x₂=1=\hat{x}₂ (wherein x₂ is a transmitted signal), the shortest Euclidean distance P₂¹=∥Y−Hx∥²=∥n∥² of the Euclidean distances from all the possible transmitted signal vectors x with b₂=1 to the received signal vector y can be obtained. With x₁=1=\hat{x}₁ and x₂=1=\hat{x}₂, since P₂¹ is the shortest Euclidean distance (i.e., ∥n∥²), the SD module 310 can obtain this value in most cases. Contrarily, when the signal x² at the second level satisfies X₂=−1≠\acute{x}₂ (i.e., the bit b₂ is erroneous), the shortest Euclidean distance P₂⁰=∥y=Hx∥²=[h₁₂h_{22]}^{T}(x₂−\hat{x}₂)+[n₁n₂]^{T}∥² of the Euclidean distances from all the signal vectors with b₂=0 to the received signal vector y can be obtained. In the present example, the shortest Euclidean distance P₂⁰ of the Euclidean distances from the signal vectors corresponding to b₂=0 to the received signal vector y cannot be obtained through the searching and calculation of the SD module 310.

Assuming that the signal \hat{x}₂ at the second level is correct (i.e., x₂=1=\hat{x}₂), the calculation of the erroneous vector in the maximum likelihood judgment is expressed as y−Hx=[h₁₁ h_{21]}^{T}(x₁−\hat{x}₁)+[n₁n_{2]}^{T}. When the signal x₁ at the first level satisfies x₁=1=\hat{x}₁, the shortest Euclidean distance P₁¹=∥y−Hx∥²=∥n∥² of the Euclidean distances from all the signal vectors x with b₁=1 to the received signal vector y is obtained. With x₁=1=\hat{x}₁ and x₂=1=\hat{x}₂, since P₁¹ is the shortest Euclidean distance (i.e., ∥n∥²), the SD module 310 can obtain this value in most cases. Contrarily, when the signal x₁ at the first level satisfies x₁=−1≠\hat{x}₁ (i.e., the bit b₁ is erroneous), the shortest Euclidean distance P₁⁰=∥y=Hx∥²=∥[h₁₁ h_{21]}^{T}(x₁−\hat{x}₁)+[n₁n_{2]}^{T}∥² of the Euclidean distances from all the signal vectors with b₁=0 to the received signal vector y can be obtained. In the present example, the shortest Euclidean distance P₁⁰ of the Euclidean distances from the signal vectors corresponding to b₁=0 to the received signal vector y can be obtained through the searching and calculation of the SD module 310.

Accordingly, in the soft demapping method provided in the present exemplary embodiment, each shortest Euclidean distance of the Euclidean distances from all the signal vectors corresponding to those bits that cannot be obtained through signal detection to a received signal vector can be instantly obtained by using channel state information (CSI) and a modulation scheme. In foregoing exemplary embodiment, when SD is executed as the signal detection, the shortest Euclidean distances P₂⁰ that are not obtained through the signal detection can be instantly obtained through the formula P₂⁰=∥y−Hx∥²=∥[h₁₂h_{22]}^{T}(x₂−\hat{x}₂)+[n₁n_{2]}^{T}∥². Thereby, the complete bit vector-shortest distance mapping table 350 is established, and a soft demapping operation can be executed according to the bit vector-shortest distance mapping table 350.

Below, the formula for instantly calculating the shortest one of the Euclidean distances from all the signal vectors corresponding to those bits that cannot be obtained through the signal detection to the received signal vector will be generally deduced. The formula for instantly calculating the shortest one of the Euclidean distances from the signal vectors corresponding to those bits that are not obtained through signal detection to the received signal vector is expressed as Pⱼ=E[∥y−Hzⱼ∥²], wherein Pⱼ represents the shortest one of the Euclidean distances from the signal vectors containing the determined signal xⱼ at any level j and other signals excluding the determined signal xⱼ to the received signal vector y, xⱼ is any signal vector in a set Sₓ_{ⱼ}, j=1, . . . , N_{T}, and the set Sₓ_{ⱼ} is a set of all the possible signal vectors when the signal xⱼ is determined. The signal xⱼ is corresponding to one or multiple bits according to the modulation scheme adopted. If the QPSK technique is adopted as the modulation scheme, one signal xⱼ is corresponding to one bit bₙ, wherein n=1, . . . , N_{T}M_{c}. When the QPSK technique is adopted, there is M_{c}=1. Thus, in the present example, bₙ=bⱼ. In addition, the mapping relation thereof is defined as that bⱼ=1 when xⱼ=1 and bⱼ=0 when xⱼ=1. Assuming that the SNR is very high and the transmitted bit is bⱼ=1 (i.e., xⱼ=1), the shortest Euclidean distance Pⱼ=E[∥y−Hxⱼ∥²]=E[∥n∥²] is obtained through SD, which is the bit vector shortest distance corresponding to bⱼ=1. When a limited number of signals are searched through SD, the bit vector shortest distance corresponding to bⱼ=0 may not be obtained. Thus, foregoing formula (Pⱼ=E[∥y−Hxⱼ∥²]) is further deduced. If the SNR is very high, signals other than the signal xⱼ are transmitted signals. Thus, only the weight of the signal xⱼ and noises are left in E[∥y=Hxⱼμ²], and Pⱼ≈E[∥hⱼ(xⱼ=\hat{x}ⱼ)+n∥²]=E[(hⱼ(xⱼ−\hat{x}ⱼ)+n)^{H}hⱼ(xⱼ−\hat{x}ⱼ)+n)], wherein hⱼ is a column vector on the column j of the system channel matrix H.

The formula for calculating the shortest Euclidean distance Pⱼ can be further expanded into Pⱼ=E[(xⱼ−\hat{x}ⱼ)²hⱼ^{H}hⱼ+(xⱼ−\hat{x}ⱼ)hⱼ^{H}n^{H}hⱼ*xⱼ−\hat{x}ⱼ)+n^{H}n]. If the column vector hⱼ at the column j of the system channel matrix H and the noise vector n are uncorrelated to each other, the calculation formula of Pⱼ can be expressed as Pⱼ=E[(xⱼ−\hat{x}ⱼ)²hⱼ^{H}hⱼ+n^{H}n]=K×E[∥hⱼ∥²]+E[∥n∥²]. Herein the column vector hⱼ at the column j of the system channel matrix H can be obtained from the CSI. K is a modulation coefficient, and the value thereof is related to the modulation scheme adopted. To be specific, the modulation coefficient K is related to the signal \hat{x}ⱼ and the constellation map of erroneous bits.

In order to establish the complete bit vector-shortest distance mapping table instantly, when the bit vector shortest distance of any bit bₙ corresponding to any signal xⱼ is not obtained through signal detection, each shortest Euclidean distance from the signal vectors with the assumption that the signal xⱼ the level j is erroneous and the signals x_{i,i≠j} at other levels are all correct to the received signal vector y is multiplied by the corresponding modulation coefficients K, and besides, the noise factor is added to the product.

However, in order to obtain a more precise result, the modulation coefficients K are related to the signal \hat{x}ⱼ solved by the communication system, a modulation scheme of the erroneous bits of the signal \hat{x}ⱼ, and the positions of the erroneous bits on the constellation map. In other words, the shortest Euclidean distance from all the signal vectors with the corresponding bit bₙ being erroneous when the signal xⱼ at the level j is erroneous and the signals x_{i,i≠j} at other levels are all correct to the received signal vector y varies with the modulation coefficients K.

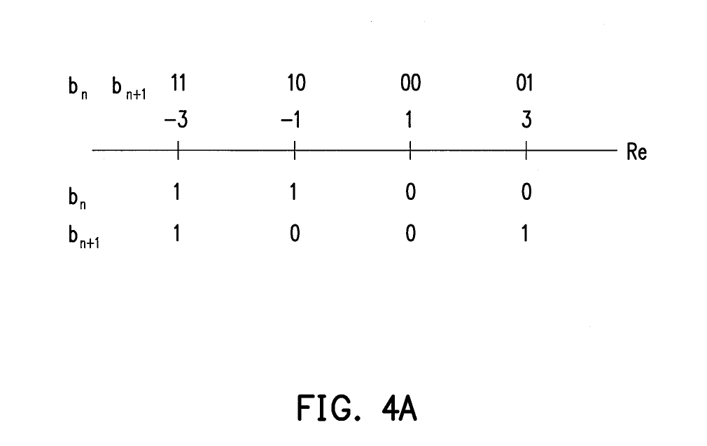

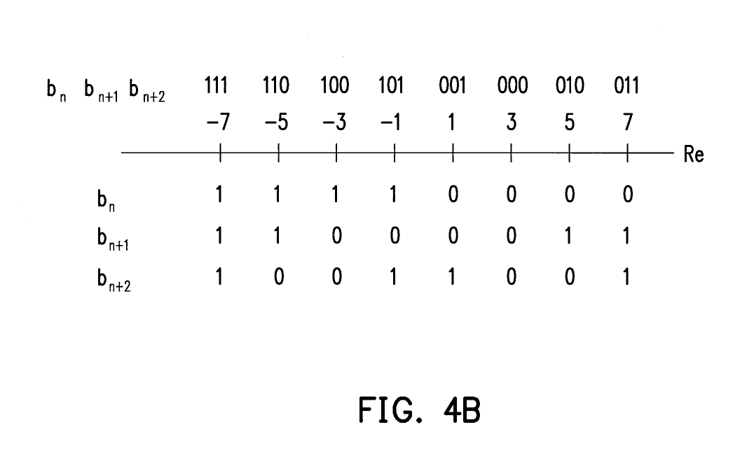

For example, when the QPSK technique is adopted, the modulation coefficients are all K=(2/\sqrt{2})². Another example will be described herein. FIG. 4A is a schematic diagram illustrating bₙ bₙ₊₁={11, 10, 00, 01} corresponding to signals xⱼ={−3, −1, 1, 3} when a communication system adopts a 16 quadrature amplitude modulation (16QAM) technique, wherein the bits bₙ and bₙ₊₁ are on the real number axis. The 16QAM technique adopted as shown in FIG. 4A is a modulation technique adopted by a long term evolution (LTE) communication system. As shown in FIG. 4A, when the real signal \hat{x}ⱼ=±3, the bit value different from the bit bₙ is not located beside the bit bₙ. Thus, the modulation coefficients are K_{16QAM}^{b}^{ₙ}^{,x}^{ⱼ}=(4/\sqrt{10})². When the real signal \hat{x}ⱼ=±1, the bit value different from the bit bₙ is located beside the bit bₙ. Thus, the modulation coefficients are K_{16QAM}^{b}^{ₙ}^{,x}^{ⱼ}=(2/\sqrt{10})². As to the bit bₙ₊₁, the bit value different from the bit bₙ₊₁ is always located beside the bit bₙ₊₁ regardless of the value of the real signal. Thus, the modulation coefficients corresponding to the bit bₙ₊₁ are all K_{16QAM}^{b}^{ₙ₊₁}^{,x}^{ⱼ}=(2/\sqrt{10})².

A LTE communication system adopting a 64 quadrature amplitude modulation (64QAM) technique will be further described as an example, as shown in FIG. 4B. FIG. 4B is a schematic diagram illustrating three bits bₙ, bₙ₊₁, and bₙ₊₂ on the real number axis when a communication system adopts a 64QAM technique. To the bit bₙ, the modulation coefficients are K_{64QAM}^{b}^{ₙ}^{,x}^{ⱼ}=(8/\sqrt{42})² when the real signal \hat{x}ⱼ=±7, the modulation coefficients are K_{64QAM}^{b}^{ₙ}^{,x}^{ⱼ}=(6/\sqrt{42})² when the real signal \hat{x}ⱼ=±5, the modulation coefficients are K_{64QAM}^{b}^{ₙ}^{,x}^{ⱼ}=(4/\sqrt{42})² when the real signal \hat{x}ⱼ=±3, and the modulation coefficients are K_{64QAM}^{b}^{ₙ}^{,x}^{ⱼ}=(2/\sqrt{42})² when the real signal \hat{x}ⱼ=±1. To the bit bₙ₊₁, the modulation coefficients are K_{64QAM}^{b}^{ₙ₊₁}^{,x}^{ⱼ}=(4/\sqrt{42})² when the real signal \hat{x}ⱼ=±7 or ±1, and the modulation coefficients are K_{64QAM}^{b}^{ₙ₊₁}^{,x}^{ⱼ}=(4/\sqrt{42})² when the real signal or \hat{x}ⱼ=±5 or ±3. To the bit bₙ₊₂, the modulation coefficients are all K_{64QAM}^{b}^{ₙ₊₂}^{,x}^{ⱼ}=(2/\sqrt{42})².

Thereby, when the signal xⱼ at the level j is erroneous and the signals x_{i,i≠j} at other levels are all correct, the shortest Euclidean distance P_{j,n} of the Euclidean distances from all the signal vectors with each of the bits bₙ, . . . , and b_{n+M}_{_{c}}₋₁ being erroneous to the received signal vector y can be expressed as P_{j,n}=K_{Modulation}^{b}^{ₙ}^{,x}^{ⱼ}×E[∥hⱼ∥²]+E[∥n∥²]. As described above, if slight imprecision is allowed, the shortest one of the Euclidean distances from all the signal vectors with each of the bits bₙ, . . . , and b_{n+M}_{_{c}}₋₁ being erroneous to the received signal vector y when the signal xⱼ at the level j is incorrect and the signals x_{i,i≠j} at other levels are all correct can be set to P_{j,n}=K×E[∥hⱼ∥²]+E[∥n∥²], wherein the modulation coefficient K may be one of the K_{Modulation}^{b}^{ₙ}^{,x}^{ⱼ}, the weighted average thereof, or a value between the maximum value and the minimum value of the modulation coefficients K_{Modulation}^{b}^{ₙ}^{,x}^{ⱼ}. Both Pⱼ and P_{j,n} are Euclidean distances, and the difference between the two is that the value of K in the Euclidean distance P_{j,n} is related to the shortest distance between two different bits having different modulation schemes, while the value of K in the Euclidean distance Pⱼ is only related to the modulation coefficients corresponding to different modulation schemes.

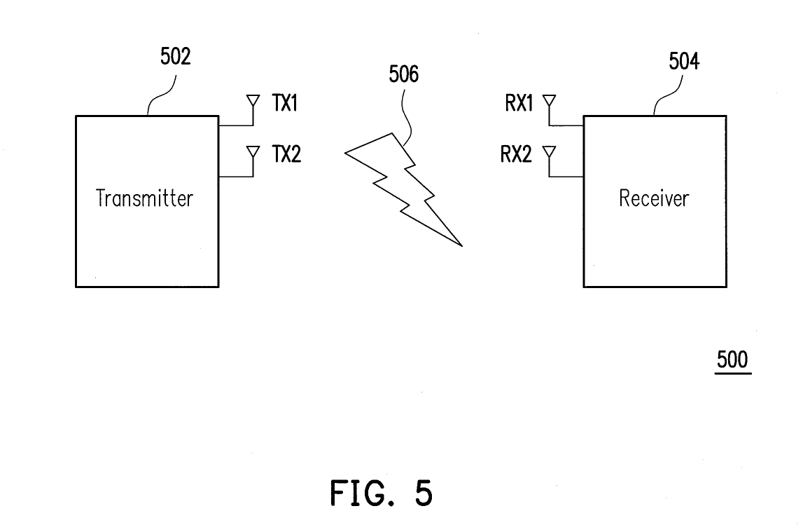

FIG. 5 is a block diagram of a communication system according to the present exemplary embodiment. Referring to FIG. 5, the communication system 500 includes a transmitter 502 and a receiver 504. The transmitter 502 performs wireless communications with the receiver 504 through a wireless channel 506. The transmitter 502 has two transmitting antennas TX1-TX2. The receiver 504 has two receiving antennas RX1-RX2. Assuming that the real signal and the imaginary signal can be processed individually and the communication system 500 adopts the 16QAM technique, each transmitted real signal vector has two signal levels, and similarly, each transmitted imaginary signal vector also has two signal levels. Besides, in the present exemplary embodiment, the real received signal vectors and the imaginary received signal vectors transmitted by the two transmitting antennas TX1-TX2 form a signal vector having eight signal levels. The real received signal vector and the imaginary received signal vector can be demapped to obtain the corresponding bit vector.

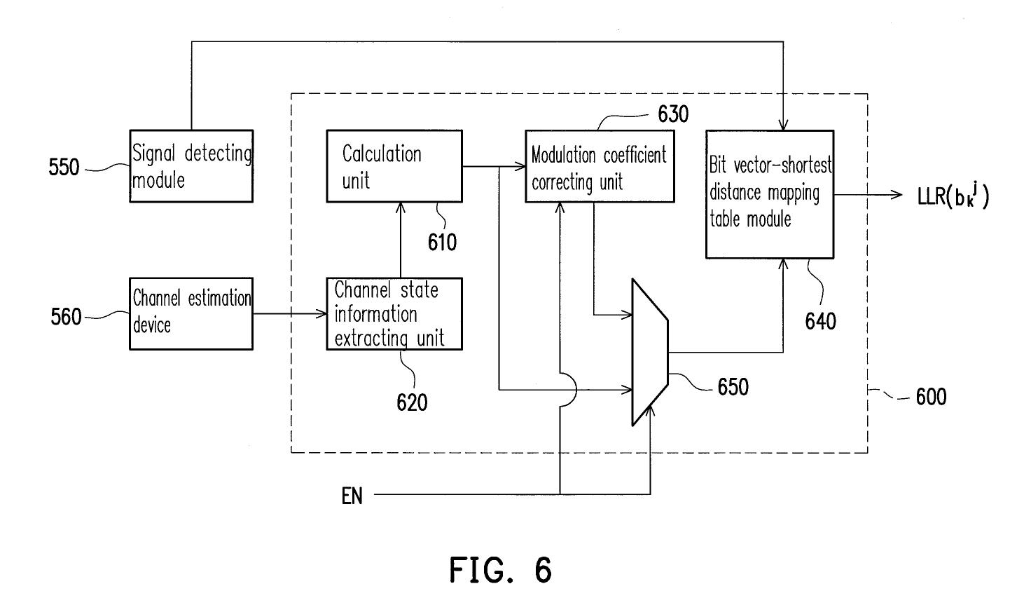

FIG. 6 is a block diagram of a soft demapping apparatus according to the present exemplary embodiment. Referring to FIG. 6, the receiver 504 includes a signal detecting module 550, a channel estimation device 560, and a soft demapping apparatus 600. The soft demapping apparatus 600 includes a calculation unit 610, a CSI extracting unit 620, a modulation coefficient correcting unit 630, a bit vector-shortest distance mapping table module 640, and a multiplexer 650. The soft demapping apparatus 600 is connected to the signal detecting module 550 and the channel estimation device 560. The CSI extracting unit 620 is connected to the channel estimation device 560. The bit vector-shortest distance mapping table module 640 is connected to the signal detecting module 550. The calculation unit 610 is connected to the CSI extracting unit 620, the modulation coefficient correcting unit 630, and the multiplexer 650. The modulation coefficient correcting unit 630 is connected to the multiplexer 650. The bit vector-shortest distance mapping table module 640 is connected to the multiplexer 650.

The signal detecting module 550 searches for the signal vector \hat{x} closest to the received signal vector y in a set S containing all or part of the signal vectors and the Euclidean distance thereof. When the signal detecting module 550 searches the set S, it may also record the Euclidean distances from some other signal vectors to the received signal vector y, wherein the signal detecting module 550 may be a MLD module or a SD module. The channel estimation device 560 estimates the wireless channel 506 to obtain a system channel matrix H. The CSI extracting unit 620 obtains each column vector hⱼ of the system channel matrix H.

The bit vector-shortest distance mapping table module 640 establishes an incomplete bit vector-shortest distance mapping table according to the Euclidean distances from some other signal vectors to the received signal vector y obtained by the signal detecting module 550 and the Euclidean distance from the signal vector \hat{x} to the received signal vector y. The completeness of the incomplete bit vector-shortest distance mapping table is determined by the size of the searched transmitted signal set, and the smaller the transmitted signal set is, the more incomplete the bit vector-shortest distance mapping table is. To simplify the calculation, the modulation coefficient K may be one of K_{Modulation}^{b}^{ₙ}^{,x}^{ⱼ} or the weighted average thereof. In other words, the modulation coefficient K may be a specific value. Herein the enabling signal EN is at a low level, the modulation coefficient correcting unit 630 is disabled, and the multiplexer 650 directly outputs P_{j,n}=K×E[∥hⱼ∥²]+E[∥n∥²] calculated by the calculation unit 610 to the bit vector-shortest distance mapping table module 640.

The calculation unit 610 calculates the values to be filled into those blank fields of the incomplete bit vector-shortest distance mapping table through foregoing calculation formula of the shortest Euclidean distances P_{j,n}. Namely, when the signal xⱼ at the level j is incorrect and the signals x_{i,i≠j} at other levels are all correct, the shortest one of the Euclidean distances from all the signal vectors with each bit bₙ being erroneous to the received signal vector y is calculated by using the calculation formula of the shortest Euclidean distances P_{j,n}. However, as described above, the modulation coefficient K is related to the modulation scheme of the signal \hat{x}ⱼ. Thus, in order to increase the precision of the soft demapping, the enabling signal EN is switched to a high level. In this case, the modulation coefficient correcting unit 630 is enabled, and the multiplexer 650 outputs the shortest Euclidean distances P_{j,n} corrected by the modulation coefficient correcting unit 630 to the bit vector-shortest distance mapping table module 640. Namely, the modulation coefficient correcting unit 630 outputs P_{j,n}=K_{Modulation}^{b}^{ₙ}^{,x}^{ⱼ}×E[∥hⱼ∥²]+E[∥n∥²] to the bit vector-shortest distance mapping table module 640 through the multiplexer 650. After the complete bit vector-shortest distance mapping table is established, the bit vector-shortest distance mapping table module 640 calculates the LLR L(bₙ) of each bit bₙ according to the complete bit vector-shortest distance mapping table, wherein n=1, . . . , N_{T}M_{c}.

It should be noted that the soft demapping apparatus 600 can perform either off-line or on-line calculations. Herein the off-line calculations refer to that the soft demapping apparatus 600 calculates the shortest Euclidean distance Pⱼ of the Euclidean distances from the corresponding signal vectors with each bit bₙ being erroneous when the signal xⱼ at the level j is incorrect and the signals x_{i,j≠j} at other levels are all correct and the received signal vector y according to the channel estimation value, the noise value, and the modulation scheme and records the shortest Euclidean distances Pⱼ into the corresponding fields of the bit vector-shortest distance mapping table when the signal detecting module 550 does not execute any calculation or searching operation. Then, when the signal detecting module 550 starts to execute its calculation and searching operations, it updates the fields in the bit vector-shortest distance mapping table that have previously recorded the shortest Euclidean distances Pⱼ according to the operation result of the signal detecting module 550 and the shortest Euclidean distances P_{j,n} calculated by the soft demapping apparatus 600.

Additionally, the on-line calculations refer to that the soft demapping apparatus 600 only calculates the shortest Euclidean distance Pⱼ or P_{j,n} of the Euclidean distances from the corresponding signal vectors with each bit being erroneous when the signal xⱼ at the level j is incorrect while the signals x_{i,i≠j} at other levels are correct to the received signal vector y and records the value into a block field of the bit vector-shortest distance mapping table after the signal detecting module 550 starts to execute its calculating and searching operations.

Moreover, it should be noted that if the signal detecting module 550 is a MLD module, the signal detecting module 550 may only store the signal vector \hat{x} closest to the received signal vector y and the Euclidean distance thereof. Thus, the bit vector-shortest distance mapping table only records the each shortest Euclidean distance of the Euclidean distances from a plurality of signal vectors corresponding to the bits of the signal vector \hat{x} to the received signal vector y. The shortest one of the Euclidean distances from the signal vectors with each erroneous bit to the received signal vector is obtained through foregoing calculation formula of the shortest Euclidean distance Pⱼ or P_{j,n}.

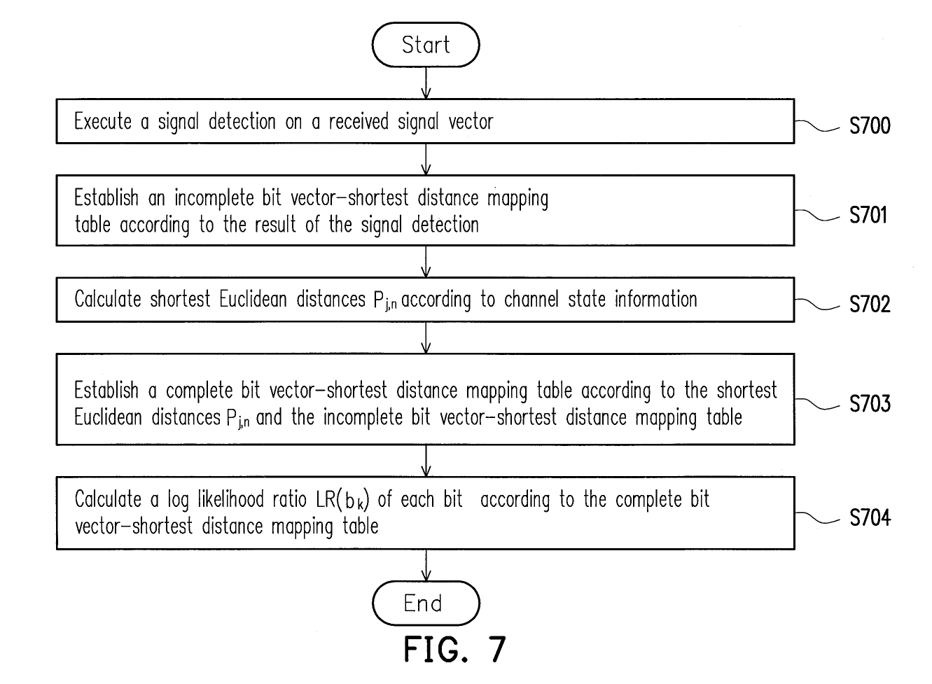

FIG. 7 is a flowchart of a soft demapping method according to the present exemplary embodiment. Referring to FIG. 7, the soft demapping method is adaptable to a receiver in a communication system for establishing a complete bit vector-shortest distance mapping table, such that the receiver can obtain the LLR of each bit in a received signal vector according to the bit vector-shortest distance mapping table. The receiver receives the received signal vector y=[y₁y₂ . . . y_{N}_{_{R}}]^{T}. All the possible signal vectors transmitted by a transmitter in the communication system are expressed as x=[x₁ x₂ . . . x_{N}_{_{T}}]^{T}, and the signal xⱼ at each level is corresponding to a plurality of bits [b_{l-1)Mc+1}b_{(l-1)Mc+2} . . . b_{(l-1)Mc+Mc]}^{T}, wherein l=2j−1 corresponds to the real bits, and the l=2j corresponds to the imaginary bits, j is an integer from 1 and N_{T}, N_{T} is a total signal number of the possible signal vector, and M_{c} is the number of real or imaginary bits corresponding to the signal xⱼ at the level j.

First, in step S700, a signal detection (for example, SD or MLD) is executed on the received signal vector y to obtain the signal vector \hat{x} closest to the received signal vector y. At the same time when the signal detection is executed, the Euclidean distances of the signal vector \hat{x} and some other signal vectors to the received signal vector y are recorded. Then, in step S701, an incomplete bit vector-shortest distance mapping table is established according to the Euclidean distances of the signal vector \hat{x} and the other signal vectors to the received signal vector y. The completeness of the incomplete bit vector-shortest distance mapping table is determined by the size of the searched transmitted signal set, and the smaller the transmitted signal set is, the more incomplete the incomplete bit vector-shortest distance mapping table is. It should be noted that only the Euclidean distance form the signal vector \hat{x} to the received signal vector y may be recorded when the signal detection is executed.

Next, in step S702, the shortest Euclidean distance P_{j,n} of the Euclidean distances from the signal vectors with each bit bₙ being erroneous when the signal xⱼ at the level j is incorrect while the signals x_{i,i≠j} at other levels are all correct to the received signal vector y is calculated according to each column vector hⱼ of the system channel matrix H, wherein n is an integer from 1 to N_{T}M_{c}. To be specific, in step S702, those missing values in the incomplete bit vector-shortest distance mapping table established in step S701 are calculated, and if some bit vector shortest distances corresponding to the signal Xⱼ at the level j are not obtained through the signal detection, the shortest Euclidean distance P_{j,n} of the Euclidean distances from the corresponding signal vectors with each bit bₙ being erroneous when the signal Xⱼ at the level j is incorrect while the signals x_{i≠j} at other levels are all correct to the received signal vector y is calculated according to each column vector hⱼ of the system channel matrix H

It should be noted that the execution order of the steps S701 and S702 can be reversed. Namely, in step S702, each column vector hⱼ is roughly estimated, and all the bit vector shortest distances are recorded in the bit vector-shortest distance mapping table. Then, in step S701, the corresponding value in the bit vector-shortest distance mapping table is updated if a specific bit vector shortest distance is obtained. After that, in step S703, a complete bit vector-shortest distance mapping table is established according to the shortest Euclidean distances P_{j,n} and the incomplete bit vector-shortest distance mapping table. Thereafter, in step S704, the LLR L(bₙ) of each bit bₙ is calculated according to the complete bit vector-shortest distance mapping table.

Herein it should be noted that if slight imprecision is allowed, the shortest Euclidean distance P_{j,n} is equal to the shortest Euclidean distance Pⱼ. Namely, the distance from each bit to the closest different value in different modulation scheme is not considered. Besides, the flowchart in FIG. 7 is not intended to limit the soft demapping method provided in the present exemplary embodiment, and as described above, off-line or on-line operations can be executed in the soft demapping method provided by an exemplary embodiment of the present disclosure. Thus, step S702 can be executed before step S700, and herein the shortest Euclidean distance P_{j,n} is equal to the shortest Euclidean distance Pⱼ or a approximated value h (i.e. h is a roughly estimated value or an average value of the Euclidean distances).

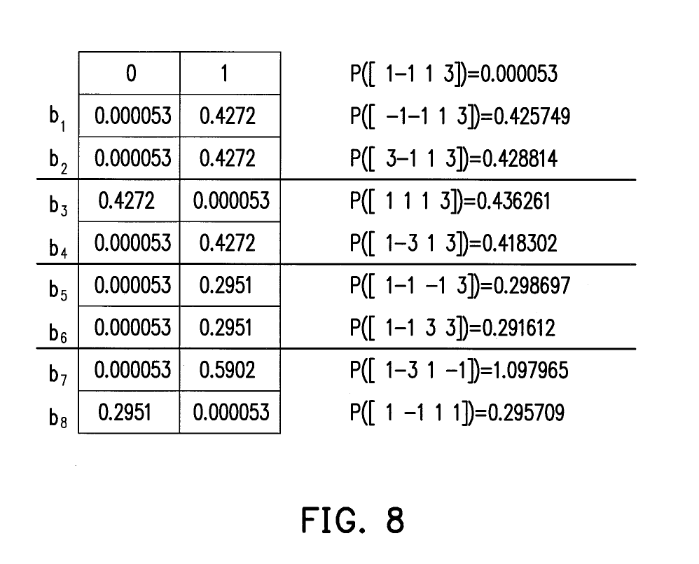

FIG. 8 is a schematic diagram of a bit vector-shortest distance mapping table according to the present exemplary embodiment. Referring to FIG. 8, in the present exemplary embodiment, the communication system adopts the 16QAM technique, the receiver and the transmitter respectively have two antennas, and the real signal and the imaginary signal are processed individually. Thus, the received signal vector y has four levels of real received signals y₁-y₄, and the signal vector X to be transmitted by the transmitter also has four levels of real signals x₁-x₄. Namely, the received signal vector y=[y₁^{R}+jy₁^{I}y₂^{R}+jy₂^{I}]^{T} can be expanded into y=[y₁^{R}y₁^{I}y₂^{R}y₂^{I}]^{T}, and the transmitted signal vector x=[X₁^{R}+jx₁^{I}x₂^{R}+jx₂^{I}]^{T} can be expanded into x=[x₁^{R}x₁^{I}x₂^{R}x₂^{I}]^{T}. If the SNR is very high, after the receiver executes a MLD on the received signal vector y, it obtains a signal vector equal to the transmitted signal vector \hat{x}=[\hat{x}₁^{R}\hat{x}₁^{I}\hat{x}₂^{R}\hat{x}₂^{I}]^{T}, and the Euclidean distance from the signal vector \hat{x} to the received signal vector y is 0.000053.

Referring to both FIG. 4A and FIG. 8, the bit vector corresponding to the signal vector \hat{x}=[\hat{x}₁^{R}\hat{x}₁^{I}\hat{x}₂^{R}\hat{x}₂^{I}] is \hat{b}=[\hat{b}₁\hat{b}₂\hat{b}₃\hat{b}₄\hat{b}₅\hat{b}₆\hat{b}₇\hat{b}_{8]}^{T}, wherein \hat{x}₁^{R} is corresponding to \hat{b}₁ and \hat{b}², and so on. As shown in FIG. 4A, since the bit vector \hat{b}=[0 0 1 0 0 0 0 1]^{T} is corresponding to the signal vector \hat{x}=[1 −1 1 3]^{T}, in the bit vector-shortest distance mapping table illustrated in FIG. 8, each shortest Euclidean distances of the Euclidean distances from all the signal vectors with b₁=0, b₂=0, b₃=1, b₄=0, b₅=0, b₆=0, b₇=0, and b₈=1 to the received signal vector y are all 0.00053. Below, for convenience of description, the signal vector \hat{x}=[\hat{x}₁^{R}\acute{x}₁^{I}\hat{x}₂^{R}\hat{x}₂^{I}] is assumed to be \hat{x}=[x₁x₂x₃x₄].

To obtain the shortest one of the Euclidean distances from all the corresponding signal vectors with b₁=1 and b₂=1 to the received signal vector y, it is assumed that the signal x₁ at the first level is incorrect, and the signals x₂, x₃, and X₄ at other levels are all correct, so that the shortest Euclidean distance from all the corresponding signal vectors with the bits b₁ and b₂ being erroneous to the received signal vector y can be calculated through foregoing calculation formula of P_{j,n}. In the example illustrated in FIG. 8, it is obtained that \hat{b}₁=0. Thus, if the bit b₁ is incorrect, the corresponding signal is x₁=−1 when b₁=1 is closest to \hat{b}₁=0. Thus, the modulation coefficient is K_{16QAM}^{b}^{₁}^{,x}^{₁}=(2/\sqrt{10})². Additionally, as to \hat{b}²=0, if the bit b² is incorrect, the corresponding signal is x₁=3 when b₂=1 is closest to \hat{b}₂=0. Thus, the modulation coefficient is K_{16QAM}^{b}^{₂}^{,x}^{₁}=(1/\sqrt{10})². Accordingly, the shortest Euclidean distance is obtained as P_{1,1}¹=P_{1,2}¹=0.4272, and the shortest Euclidean distances P_{1,1}¹=P_{1,2}¹=0.4272 are filled in the fields corresponding to b₁=1 and b₂=1.

However, if all the signal vectors with the bit b₁ being erroneous are to be actually searched, the signal vector closest to the received signal vector y among all the signal vectors with the bit b₁ in the signal vector x=[−1 −1 1 3]^{T} being erroneous can be obtained, and the distance from the signal vector x=[−1 −1 1 3]^{T} to the received signal vector y is 0.425749. Besides, if all the signal vectors with the bit b₂ being erroneous are to be actually searched, the signal vector closest to the received signal vector y among all the signal vectors with the bit b₂ in the signal vector x=[3 −1 1 3]^{T} being erroneous can be obtained, and the distance from the signal vector x=[3 −1 1 3]^{T} to the received signal vector y is 0.428814. Thus, the shortest Euclidean distances P_{1,1}¹=P_{1,2}¹=0.4272 calculated through the formula provided by an exemplary embodiment of the present disclosure are very close to the actual shortest Euclidean distances.

To obtain the shortest Euclidean distance of the Euclidean distances from all the corresponding signal vectors with b₃=0 and b₄=1 to the received signal vector y, it is assumed that the signal x₂ at the second level is incorrect, and the signals x₁, x₃, and x₄ at other levels are all correct, so that the shortest Euclidean distance of the Euclidean distances from all the corresponding signal vectors to the bits b₃ and b₄ being erroneous and the received signal vector y can be calculated through foregoing calculation formula of P_{j,n}. In the example illustrated in FIG. 8, it is obtained that \hat{b}₁=0. Thus, if the bit b₃ is incorrect, the corresponding signal is x₂=1 when b₃=0 is closest to \hat{b}₃=1. Thus, the modulation coefficient is K_{16QAM}^{b}^{₃}^{,x}^{₂}=(2/\sqrt{10})². Additionally, as to \hat{b}₄=0, if the bit b₄ is incorrect, the corresponding signal is x₂=−3 when b₄=1 is closest to \hat{b}₄=0. Thus, the modulation coefficient is K_{16QAM}^{b}^{₄}^{,x}^{₂}=(2/\sqrt{10})². Accordingly, the shortest Euclidean distance is obtained as P_{2,3}⁰=P_{2,4}¹=0.4272, and the shortest Euclidean distances P_{2,3}⁰=P_{2,4}¹=0.4272 are filled in the fields corresponding to b₃=0 and b₄=1.

However, if all the signal vectors with the bit b₃ being erroneous are to be actually searched, the signal vector closest to the received signal vector y among all the signal vectors with the bit b₃ in the signal vector x=[1 1 1 3]^{T} being erroneous can be obtained, and the distance from the signal vector x=[1 1 1 3]^{T} to the received signal vector y is 0.436261. Besides, if all the signal vectors with the bit b₄ being erroneous are to be actually searched, the signal vector closest to the received signal vector y among all the signal vectors with the bit b₄ in the signal vector x=[1 −3 1 3]^{T} being erroneous can be obtained, and the distance from the signal vector x=[1 −3 1 3]^{T} to the received signal vector y is 0.418302. Thus, the shortest Euclidean distances P_{2,3}⁰=P_{2,4}¹=0.4272 calculated through the formula provided by an exemplary embodiment of the present disclosure are very close to the actual shortest Euclidean distances.

To obtain the shortest one of the Euclidean distances from all the corresponding signal vectors with b₁=1 and b₂=1 to the received signal vector y, it is assumed that the signal x₃ at the third level is incorrect, and the signals x₁, x₂, and x₄ at other levels are all correct, so that the shortest one of the Euclidean distances from all the corresponding signal vectors with the bits b₅ and b₆ being erroneous to the received signal vector y can be calculated through foregoing calculation formula of P_{j,n}. In the example illustrated in FIG. 8, it is obtained that \hat{b}₅=0. Thus, if the bit b₅ is incorrect, the corresponding signal is x₃=−1 when b₅=1 is closest to \hat{b}₅=0. Thus, the modulation coefficient is K_{16QAM}^{b}^{₅}^{,x}^{₃}=(2/\sqrt{10})². Additionally, as to b₆=0, if the bit b₆ is incorrect, the corresponding signal is x₃3 when b₆=1 is closest to \hat{b}₆=0. Thus, the modulation coefficient is K_{16QAM}^{b}^{₆}^{,x}^{₃}=(2/\sqrt{10})². Accordingly, the shortest Euclidean distance is obtained as P_{3,5}¹=P_{3,6}¹=0.2951, and the shortest Euclidean distances P_{3,5}¹=P_{3,6}¹=0.2951 are filled in the fields corresponding to b₅=1 and b₆=1.

However, if all the signal vectors with the bit b₅ being erroneous are to be actually searched, the signal vector closest to the received signal vector y among all the signal vectors with the bit b₅ in the signal vector x=[1 −1 −1 3]^{T} being erroneous can be obtained, and the from the signal vector x=[1 −1 −1 3]^{T} to the received signal vector y is 0.298697. Besides, if all the signal vectors with the bit b₆ being erroneous are to be actually searched, the signal vector closest to the received signal vector y among all the signal vectors with the bit b₆ in the signal vector x=[1 −1 3 3]^{T} being erroneous can be obtained, and the distance from the signal vector x=[1 −1 3 3]^{T} to the received signal vector y is 0.291612. Thus, the shortest Euclidean distances P_{3,5}¹=P_{3,6}¹=0.2951 calculated through the formula provided by an exemplary embodiment of the present disclosure are very close to the actual shortest Euclidean distances.

To obtain the shortest one of the Euclidean distances from all the corresponding signal vectors with b₇=1 and b₈=0 to the received signal vector y, it is assumed that the signal x₄ at the fourth level is incorrect, and the signals x₁, x₂, and x₃ at other levels are all correct, so that the shortest one of the Euclidean distances from all the corresponding signal vectors with the bits b₇ and b₈ being erroneous to the received signal vector y can be calculated through foregoing calculation formula of P_{j,n}. In the example illustrated in FIG. 8, it is obtained that \hat{b}₇=0. Thus, if the bit b₇ is incorrect, the corresponding signal is s₄=−1 when b₇=1 is closest to b₇=0. Thus, the modulation coefficient is K_{16QAM}^{b}^{₇}^{,x}^{₄}=(4/\sqrt{10})². Additionally, as to \hat{b}₈=1, if the bit b₈ is incorrect, the corresponding signal is x₄=1 when b₈=0 is closest to \hat{b}₈=1. Thus, the modulation coefficient is K_{16QAM}^{b}^{₈}^{,x}^{₄}=(2/\sqrt{10})². Accordingly, the shortest Euclidean distance is obtained as P_{4,7}¹=0.5902 and P_{4,8}⁰=0.2951 and the shortest Euclidean distances P_{4,7}¹=0.5902 and P_{4,8}⁰=0.2951 are respectively filled in the fields corresponding to b₇=1 and b₈=0.

However, if all the signal vectors with the bit b₇ being erroneous are to be actually searched, the signal vector closest to the received signal vector y among all the signal vectors with the bit b₇ in the signal vector x=[1 −3 1 31 1]^{T} being erroneous can be obtained, and the from the signal vector x=[1 31 3 1 31 1]^{T} to the received signal vector y is 1.097965. Besides, if all the signal vectors with the bit b₈ being erroneous are to be actually searched, the signal vector closest to the received signal vector y among all the signal vectors with the bit b₈ in the signal vector x=[1 −1 1 1]^{T} being erroneous can be obtained, and the distance from the signal vector x=[1 −1 1 1]^{T} to the received signal vector y is 0.295709. Obviously, not only the signal at the fourth level in the signal vector x=[1 −3 1 −1]^{T} closest to the received signal vector y among all the corresponding signal vectors with the bit b⁷ being erroneous is incorrect. Thus, a large error exists between the shortest Euclidean distance P_{4,7}¹=0.5902 calculated through foregoing formula and the actual shortest Euclidean distance. However, even with some errors, the shortest Euclidean distance obtained through the soft demapping method provided by the present exemplary embodiment can still be used as a reference value of the shortest Euclidean distance P_{4,7}¹. In addition, the shortest Euclidean distance P_{4,8}⁰=0.2951 calculated through the formula provided by an exemplary embodiment of the present disclosure is very close to the actual shortest Euclidean distance.

It should be noted that to obtain the shortest Euclidean distance quickly, the shortest Euclidean distance may also be calculated through the calculation formula of Pⱼ. However, obviously, in the present exemplary embodiment, the shortest Euclidean distance P₄ obtained through this formula is very different from the shortest one of the Euclidean distances from all the corresponding signal vectors with the bit b₁⁴ being erroneous to the received signal vector y. Accordingly, the calculation formula of Pⱼ should be revised into the calculation formula of P_{j,k} by using variable modulation coefficients, so as to improve the calculation precision.

In summary, the soft demapping method provided by an exemplary embodiment of the present disclosure can be applied to a receiver adopting different signal detection technique, and in the soft demapping method, values corresponding to those blank fields of an incomplete bit vector-shortest distance mapping table can be obtained through simple calculations, so that the LLR of each bit can be easily calculated.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A soft demapping method, adaptable to a receiver in a communication system, for obtaining a log likelihood ratio (LLR) of each bit in a received signal vector, wherein the receiver receives the received signal vector y=[y₁y₂ . . . y_{N}_{_{R}}]^{T}, all possible signal vectors transmitted by a transmitter in the communication system are expressed as x=[x₁x₂ . . . x_{N}_{_{T}}]^{T}, and a plurality of bits corresponding to a signal xⱼ at each level is expressed as [b_{(l-1)Mc+1}b_{(l-1)Mc+2} . . . b_{(l-1)Mc+Mc}]^{T}, wherein l=2 j−1 corresponds to the real bits, and the l=2 j corresponds to the imaginary bits, j is an integer from 1 and N_{T}, N_{T} is a total signal number of the possible signal vector, and M_{c} is the number of real or imaginary bits corresponding to the signal xⱼ atthe level j, the soft demapping method comprising:
executing a signal detection on the received signal vector y to obtain an incomplete bit vector-shortest distance mapping table;
calculating each shortest Euclidean distance P_{j,n} of the Euclidean distances from the corresponding signal vectors with each bit bₙ being erroneous when the signal xⱼ at the level j is incorrect and signals x_{i,i≠j} at other levels are all correct to the received signal vector y according to each column vector hⱼ of a system channel matrix H; and
establishing a complete bit vector-shortest distance mapping table according to each shortest Euclidean distances P_{j,n} and the incomplete bit vector-shortest distance mapping table.

2. The soft demapping method according to claim 1, wherein the signal detection is a sphere decoding (SD) or a maximum likelihood detection (MLD).

3. The soft demapping method according to claim 1, wherein when the signal is detected, a signal vector \hat{x} closest to the received signal vector y is obtained, and at least the shortest Euclidean distance from the signal vector \hat{x} to the received signal vector y is recorded, so as to establish the incomplete bit vector-shortest distance mapping table.

4. The soft demapping method according to claim 3, wherein when the signal is detected, Euclidean distances from a part of the signal vectors to the received signal vector y are further recorded, and the incomplete bit vector-shortest distance mapping table is established according to the shortest Euclidean distance from the signal vector \hat{x} to the received signal vector y and the Euclidean distances from the part of the signal vectors to the received signal vector y.

5. The soft demapping method according to claim 1 further comprising:
calculating the LLR L(bₙ) of each bit bₙ according to the complete bit vector-shortest distance mapping table.

6. The soft demapping method according to claim 1, wherein the step of calculating each shortest Euclidean distance P_{j,n} is executed before the step of executing the signal detection to obtain the incomplete bit vector-shortest distance mapping table, wherein hⱼ is roughly estimated and shortest distances of all bit vectors are stored in a bit vector-shortest distance mapping table, and in the step of executing the signal detection, a corresponding value in the bit vector-shortest distance mapping table is updated when the shortest distance of a specific bit vector is obtained.

7. The soft demapping method according to claim 1, wherein the shortest Euclidean distance P_{j,n} satisfies P_{j,n}=K×E[∥hⱼ∥²]+E[∥n∥²], wherein n is a noise vector, and K is a modulation coefficient.

8. The soft demapping method according to claim 1, wherein the shortest Euclidean distance P_{j,n} satisfies P_{j,n}=K_{Modulation}^{b}^{ₙ}^{,x}^{ⱼ}×E[∥hⱼ∥²]+E[∥n∥²], wherein n is a noise vector, K_{Modulation}^{b}^{ₙ}^{,x}^{ⱼ} is a modulation coefficient, and K_{Modulation}^{b}^{ₙ}^{,x}^{ⱼ} is related to a signal \hat{x}ⱼ solved by the communication system, a modulation scheme of erroneous bits of the signal \hat{x}ⱼ, and positions of the erroneous bits on a constellation map.

9. A soft demapping apparatus, adaptable to a receiver in a communication system, for obtaining a LLR of each bit in a received signal vector, wherein the receiver receives the received signal vector y=[y₁y₂ . . . y_{N}_{_{R}}]^{T}, all possible signal vectors transmitted by a transmitter in the communication system are expressed as X=[x₁x₂ . . . x_{N}_{_{T}}]^{T}, and a plurality of bits corresponding to a signal xⱼ at each level is expressed as [b_{(l-1)Mc+1}b_{(l-1)Mc+2} . . . b_{(l-1)Mc+Mc}]^{T}, wherein l=2 j−1 corresponds to real bits, and the l=2 j corresponds to imaginary bits, j is an integer from 1 and N_{T}, N_{T} is a total signal number of the possible signal vector, and M_{c} is the number of real or imaginary bits corresponding to the signal xⱼ at the level j, the soft demapping apparatus comprising:
a bit vector-shortest distance mapping table module, for establishing a incomplete bit vector-shortest distance mapping table according to a result of a signal detection executed by a signal detecting module on the received signal vector y;
a channel state information (CSI) extracting unit, for extracting each column vector hⱼ of a system channel matrix H from a channel estimation device; and
a calculation unit, for calculating each shortest Euclidean distance P_{j,n} of the Euclidean distances from the corresponding signal vectors with each bit bₙ being erroneous when the signal xⱼ at the level j is incorrect and the signals x_{i,i≠j} at other levels are all correct to the received signal vector y according to each column vector hⱼ of the system channel matrix H;
wherein the bit vector-shortest distance mapping table module further establishes a complete bit vector-shortest distance mapping table according to each shortest Euclidean distance P_{j,n} and the incomplete bit vector-shortest distance mapping table.

10. The soft demapping apparatus according to claim 9, wherein the signal detecting module is a SD module or a MLD module.

11. The soft demapping apparatus according to claim 9, wherein when the signal detected, the signal detecting module obtains the signal vector \hat{x} closest to the received signal vector y and records at least the shortest Euclidean distance from the signal vector \hat{x} to the received signal vector y, such that the bit vector-shortest distance mapping table module to establish the incomplete bit vector-shortest distance mapping table.

12. The soft demapping apparatus according to claim 11, wherein when the signal is detected, the signal detecting module further records Euclidean distances from a part of the signal vectors to the received signal vector y, the bit vector-shortest distance mapping table module establishes the incomplete bit vector-shortest distance mapping table according to the shortest Euclidean distance from the signal vector \hat{x} to the received signal vector y and the Euclidean distances from the part of the signal vectors to the received signal vector y.

13. The soft demapping apparatus according to claim 9, wherein the bit vector-shortest distance mapping table module calculates the LLR L(bₙ) of each bit bₙ according to the complete bit vector-shortest distance mapping table.

14. The soft demapping apparatus according to claim 9, wherein the calculation unit calculates each shortest Euclidean distance P_{j,n} from the corresponding signal vectors with each bit bₙ being erroneous when the signal xⱼ at the level j is incorrect and the signals x_{i,i≠j} at other levels are all correct to the received signal vector y before the signal is detected, namely, the calculation unit obtains each roughly estimated hⱼ and stores shortest distances of all bit vectors in a bit vector-shortest distance mapping table, the bit vector-shortest distance mapping table module updates a corresponding value in the bit vector-shortest distance mapping table if the bit vector-shortest distance mapping table module obtains the shortest distance of a specific bit vector; or the calculation unit calculates each shortest Euclidean distance P_{j,n} from the corresponding signal vectors with each bit bₙ being erroneous when the signal xⱼ at the level j is incorrect and the signals x_{i,i≠j} at other levels are all correct to after the signal detected.

15. The soft demapping apparatus according to claim 9, wherein each shortest Euclidean distance P_{j,n} satisfy P_{j,n}=K×E[∥hⱼ∥²]+E[∥n∥²], wherein n is a noise vector, and K is a modulation coefficient.

16. The soft demapping apparatus according to claim 15 further comprising:
a modulation coefficient correcting unit, for correcting the shortest Euclidean distance P_{j,n}=K×E[∥hⱼ∥²]+E[∥n∥²] obtained by the calculation unit into the shortest Euclidean distance P_{j,n}=K_{Modulation}^{b}^{ₙ}^{,x}^{ⱼ}×E[∥hⱼ∥²]+E[∥n∥²],wherein n is anoise vector, K_{Modulation}^{b}^{ₙ}^{,x}^{ⱼ} is a modulation coefficient, and K_{Modulation}^{b}^{ₙ}^{,x}^{ⱼ} is related to a signal \hat{x}ⱼ solved by the communication system, a modulation scheme of erroneous bits of the signal \hat{x}ⱼ, and positions of the erroneous bits on a constellation map.

17. A communication system, comprising a receiver and a transmitter, wherein the receiver comprises a soft demapping apparatus and a signal detecting module, the soft demapping apparatus obtains a LLR of each bit in a received signal vector, the receiver receives the received signal vector y=[y₁y₂ . . . y_{N}_{_{R}}]^{T}, all possible signal vectors transmitted by a transmitter in the communication system are expressed as x=[x₁x₂ . . . x_{N}_{_{T}}]^{T}, and a plurality of bits corresponding to a signal xⱼ at each level is expressed as [b_{(l-1)Mc+1}b_{(l-1)Mc+2} . . . b_{(l-1)Mc+Mc}]^{T}, wherein l=2 j−1 corresponds to real bits, and the l=2 j corresponds to imaginary bits, j is an integer from 1 and N_{T}, N_{T} is a total signal number of the possible signal vector, and M_{c} is the number of real or imaginary bits corresponding to the signal \hat{x}ⱼ at the level j, the soft demapping apparatus comprising:
a bit vector-shortest distance mapping table module, for establishing a incomplete bit vector-shortest distance mapping table according to a result of a signal detection executed by a signal detecting module on the received signal vector y;
a channel state information (CSI) extracting unit, for extracting each column vector hⱼ of a system channel matrix H from a channel estimation device; and
a calculation unit, for calculating each shortest Euclidean distance P_{j,n} of the Euclidean distances from the corresponding signal vectors with each bit bₙ being erroneous when the signal xⱼ at the level j is incorrect and the signals x_{i,i≠j} at other levels are all correct to the received signal vector y according to each column vector hⱼ of the system channel matrix H;
wherein the bit vector-shortest distance mapping table module further establishes a complete bit vector-shortest distance mapping table according to each shortest Euclidean distance P_{j,n} and the incomplete bit vector-shortest distance mapping table.

18. The communication system according to claim 17, wherein the signal detecting module is a SD module or a MLD module.

19. The communication system according to claim 17, wherein when the signal detection detected, the signal detecting module obtains the signal vector \hat{x} closest to the received signal vector y and records at least the shortest Euclidean distance from the signal vector \hat{x} to the received signal vector y, such that the bit vector-shortest distance mapping table module to establish the incomplete bit vector-shortest distance mapping table.

20. The communication system according to claim 19, wherein when the signal is detected, the signal detecting module further records Euclidean distances from a part of the signal vectors to the received signal vector y, the bit vector-shortest distance mapping table module establishes the incomplete bit vector-shortest distance mapping table according to the shortest Euclidean distance from the signal vector \hat{x} to the received signal vector y and the Euclidean distances from the part of the signal vectors to the received signal vector y.

21. The communication system according to claim 17, wherein the bit vector-shortest distance mapping table module calculates the LLR L(bₙ) of each bit bₙ according to the complete bit vector-shortest distance mapping table.

22. The communication system according to claim 17, wherein the calculation unit calculates each shortest Euclidean distance P_{j,n} from the corresponding signal vectors with each bit bₙ being erroneous when the signal xⱼ at the level j is incorrect and the signals x_{i,i≠j} at other levels are all correct to the received signal vector y before the signal is detected, namely, the calculation unit obtains each roughly estimated hⱼ and stores shortest distances of all bit vectors in a bit vector-shortest distance mapping table, the bit vector-shortest distance mapping table module updates a corresponding value in the bit vector-shortest distance mapping table if the bit vector-shortest distance mapping table module obtains the shortest distance of a specific bit vector; or the calculation unit calculates each shortest Euclidean distance P_{j,n} from the corresponding signal vectors with each bit bₙ being erroneous when the signal xⱼ at the level j is incorrect and the signals x_{i,i≠j} at other levels are all correct to after the signal detected.

23. The communication system according to claim 17, wherein each shortest Euclidean distance P_{j,n} satisfy P_{j,n}=K×E[∥hⱼ∥²]+E[∥n∥²], wherein n is a noise vector, and K is a modulation coefficient.

24. The communication system according to claim 23, wherein the soft demapping apparatus further comprises:
a modulation coefficient correcting unit, for correcting the shortest Euclidean distance P_{j,n}=K×E[∥hⱼ∥²]+E[∥n∥²] obtained by the calculation unit into the shortest Euclidean distance P_{j,n}=K_{Modulation}^{b}^{ₙ}^{,x}^{ⱼ}×E[∥hⱼ∥²]+E[∥n∥∥²], wherein n is a noise vector, K_{Modulation}^{b}^{ₙ}^{,x}^{ⱼ} is a modulation coefficient, and K_{Modulation}^{b}^{ₙ}^{,x}^{ⱼ} is related to a signal \hat{x}ⱼ solved by the communication system, a modulation scheme of erroneous bits of the signal \hat{x}ⱼ, and positions of the erroneous bits on a constellation map.
